(19) United States
(12) Patent Application Publication
(10) Pub. No.: US 2012/0113994 A1
(43) Pub. Date: May 10, 2012

(54) LOW NOISE RAMAN LASER DEVICE, RAMAN LASER SYSTEM AND ASSOCIATED METHOD

(75) Inventors: Thierry GEORGES, PERROS GUIREC (FR); Nicolas LANDRU, PLEUMEUR BODOU (FR); Julien ROUVILLAIN, LANNION (FR)

(73) Assignee: OXXIUS, LANNION (FR)

(21) Appl. No.: 13/293,460

(22) Filed: Nov. 10, 2011

(30) Foreign Application Priority Data
Nov. 10, 2010 (FR) 10 59316

(51) Int. Cl. H01S 3/30

(52) U.S. Cl. 372/3

(57) ABSTRACT

A Raman laser device includes:
an amplifying medium (2) absorbent at a pump wavelength λ_{P} and emitting at an excitation wavelength λ_{S},
a Raman medium (3) exhibiting at least one Stokes shift Δυ_{R}, such as to convert the emission at the excitation wavelength λ_{S} into a continuous emission at a Raman wavelength λ_{R}. The amplifying medium and the Raman medium belong to a Raman cavity resonant at the excitation wavelength λ_{S} and at the Raman wavelength λ_{R}. The length of the Raman medium is less than 9 mm and the sum of the gaps between each of the elements of the Raman cavity is less than 2 mm. A system including such a Raman laser device, and a method of adjusting the Raman laser device are described.

### TECHNICAL FIELD

The present invention relates to a low noise Raman laser device, a Raman laser system comprising this Raman laser device, and to a method associated with said device.

The field of the invention is more particularly, but not in a limitative way, that of solid-state lasers using a continuous Raman emission.

### STATE OF THE PRIOR ART

Raman scattering is a third order non-linear optical process, during which an exchange of energy takes place between an excitation light beam (called a Raman pump) and a medium called a “Raman medium”. Raman scattering is called inelastic because the Raman medium modifies the frequency of the excitation light beam in order to transform it into a scattered beam or Raman beam. The frequency shift Δυ_{R} between the excitation light beam and the scattered beam is called the Stokes shift. The wavelength of the scattered beam will be called the Raman wavelength.

A Raman medium is characterized by at least one energy shift Δυ_{R} such that:

$$\frac{1}{{λ}_{R}} = \frac{1}{{λ}_{S}} - \frac{Δ {v}_{R}}{C} ,$$

where
C is the speed of light in a vacuum,
λ_{R} is the Raman wavelength,
λ_{S} is the excitation wavelength (or Raman pump wavelength).

A Raman medium can exhibit several energy shifts Δυ_{R} (the term “Raman lines” is also used). Several Raman wavelengths λ_{R} are therefore accessible. A Raman medium can be a crystal or an amorphous medium such as a glass.

Stimulated Raman scattering can amplify a signal and it is possible to produce an oscillator (the term “Raman laser” is generally used) by introducing the pumped Raman medium into a cavity that is resonant at the Raman wavelength, called a Raman cavity.

The term “Raman laser” or “Raman laser device” can refer to the assembly formed by the Raman cavity and the different elements which can be situated inside this Raman cavity.

The Raman gain is proportional to the intensity Iₛ (ratio of the power to the transverse area, expressed in GW/cm²) of the Raman pump, to the length l of the Raman medium (expressed in cm) and to an intrinsic gain coefficient of the Raman medium g_{R} (generally expressed in cm/GW). The length l of the Raman medium is the length of Raman medium traversed by the Raman pump. The transverse area of the Raman pump is the area of a cross-section of the intersection of the Raman pump with the Raman medium, preferably the cross-section perpendicular to the direction of propagation of the Raman pump in the Raman medium. The coefficient g_{R} is in general very small. For a 1064 nm Raman pump, this gain is equal to 0.01 cm/GW for the germano-silicates up to almost 10 cm/GW for the better crystals (BaWO₄ or Ba(NO₃)₂ for example).

The threshold of the Raman oscillation is reached when the Raman gain is equal to the losses in the Raman laser at the Raman wavelength. α represents these losses. For a linear cavity, we then have: P_{threshold}=απw²/2lg_{R} where w is the radius of the mode of the Raman pump and P_{threshold} is the Raman pump threshold power beyond which there is oscillation at the Raman wavelength. For example, a 100 W Raman pump, with a mode radius of 50 μm procures a Raman gain of 0.64% in a Raman medium of length 1 cm and of intrinsic gain equal to 5 cm/GW. The Raman oscillation is therefore in general reached only for high Raman pump powers, rather long Raman media and low losses.

Because of their guiding capabilities, fibres have made it possible to produce the first continuous Raman lasers. In fact, 1 W of pump injected into a germanosilicate fibre of small diameter makes it possible to reach a pump intensity of 5 MW/cm² and to maintain it over hundreds of metres. A gain of the order of 170% is obtained on a return path of 100 m, despite the weakness of the intrinsic gain.

A continuous Raman emission at a Raman wavelength λ_{R} is continuous because of a continuous pumping at the Raman pump wavelength λ_{S}.

In crystals, the absence of guiding requires a compromise between strong focusing of the Raman pump and length of the Raman medium. For example, a Raman pump beam of 10⁻⁴ cm² is collimated only over a distance of 20 mm. With 1 W of Raman pump and the best Raman crystal, 0.04% of Raman gain is obtained in round trip.

In the rest of this document, interest is more particularly taken in Raman lasers for emitting a continuous Raman beam, and in solid state Raman lasers, using solid Raman media such as crystals or glasses, as opposed to fibre lasers.

A laser emitting 100 W of power in continuous emission is generally too bulky and too expensive to be used as a Raman pump in a large majority of applications. There are several methods of reducing the power constraints on the Raman pump.

The first one consists of using a single-frequency Raman pump and in injecting it into an external resonant cavity at the wavelength of the Raman pump. This principle makes it possible to very greatly increase the power of the Raman pump inside the cavity. If this external cavity comprises the Raman medium, the threshold of the Raman oscillation can be lowered significantly. The first continuous Raman laser in crystals was produced in this way in 2004 using a 5 W Argon laser as a Raman pump (“Multimode pumped continuous-wave solid-state Raman laser”, Grabtchikov et al., Optics Letters, Vol. 29, No. 21, Nov. 1, 2004, p. 2524-2526). This latter method is difficult to use because it requires a single-frequency Raman pump and an adjustment of the phase of the external cavity.

A simpler method to use consists of superimposing a resonant cavity at the Raman pump wavelength and the Raman cavity resonating at the Raman wavelength. This type of configuration is called an “intra-cavity” Raman laser. For example, Pask in 2005 (“Continuous-wave, all-solid-state, intra-cavity Raman laser”, H. M. Pask, Optics Letters, Vol. 30, No. 18, Sep. 15, 2005, p. 2454-2456) produced such a laser with a cavity in which there is Nd:YAG (amplifier of the Raman pump at the wavelength λₛ=1064 nm) and a Raman medium (KGW crystal) making a Raman signal oscillate at the wavelength λ_{R}=1176 nm. The Stokes shift of the KGW crystal is Δυ_{R}=27 THz (or 901 cm⁻¹ in spectroscopic units). The cavity is resonant at two wavelengths λₛ and λ_{R}. It is closed by two mirrors that are highly reflective at the wavelengths λₛ and λ_{R}. The energy is provided by an external pump (diode emitting 20 W at the wavelength of λₚ=808 nm). Intra-cavity Raman lasers are rather easy to use. In such a device, three laser signals at three wavelengths are present: the pump which is absorbed by the Nd ion, the laser signal amplified by the Nd ion which is also the Raman pump and the Raman signal.

The Raman beam can also interact with the Raman medium and serve as a pump at a longer wavelength. In this case the term “first Stokes” refers to the first Raman wave also serving as a Raman pump and the term “second Stokes” refers to the second Raman wave obtained from the first Stokes. If the Raman cavity, resonant at the wavelength of the first Stokes, is also resonant at the wavelength of the second Stokes, this wavelength can reach the Raman oscillation threshold. It is possible to continue and cascade several Stokes waves.

It is also possible to introduce a non-linear crystal into the Raman cavity. The latter can be tuned in order to produce the frequency summing between the Raman pump and the Raman wave (1/λ=1/λ_{R}+1/λₛ) or the frequency doubling of the Raman wave (1/λ=2/λ_{R}). Lee et al (“Efficient 5.3 W continuous-wave laser at 559 nm by intra-cavity frequency summation of fundamental and first-Stokes wavelengths in a self Raman Nd:GdVO₄ laser”, Lee et al., Optics letters, vol. 35, 2010, p. 682-684) have thus produced a laser emitting at 559 nm (frequency summing) and Dekker and al (“Continuous-wave, intra-cavity doubled, self-Raman operation in Nd:GdVO₄ at 586.5 nm”, Peter Dekker et al., Optics Express, Vol. 15, No. 11, 28 May 2007, p. 7038-7046) have produced a 586.5 nm Raman laser (frequency doubling).

Dekker et al (“Continuous-wave, intra-cavity doubled, self-Raman operation in Nd:GdVO₄ at 586.5 nm”, Peter Dekker et al., Optics Express, Vol. 15, No. 11, 28 May 2007, p. 7038-7046) mention in particular a 13 mm Raman cavity. The authors were confronted with a thermal lens that was too strong, making a cavity of length 24 mm unstable at pump powers of more than 20 W. A simple modeling of the beam size w of a Raman laser with a lens of focal length f is in fact given by Z_{R}=πw²/λ=[l_{c}(f−l_{c})]^{1/2} where Z_{R} is the Rayleigh distance and l_{c} is the sum of the lengths of the constituent elements of the Raman laser divided by their refractive index. When the pump power Pₚ increases, the focal length of the thermal lens f(Pₚ) decreases. The Raman laser becomes unstable when f(Pₚ)<l_{c}. The authors showed that the 13 mm cavity made it possible to obtain a Raman power greater than that of the cavity of length 24 mm in the pump power range of 10 W to 22 W. Finally, as the Raman medium was of length 10 mm, the authors had to withdraw the doubling crystal in order to carry out this experiment.

A drawback of these solid-state Raman lasers is the noise. In fact, each time that the noise has been measured on this type of Raman laser, it was high, for example greater than 4% RMS (see for example “Diode-pumped continuous-wave Nd:YVO₄ laser with self-frequency Raman conversion”, Burakevich et al., Applied Physics B 86, p. 511-514, 2007, see also: “Continuous-wave, intra-cavity doubled, self-Raman operation in Nd:GdVO₄ at 586.5 nm”, Peter Dekker et al., Optics Express, Vol. 15, No. 11, 28 May 2007, p. 7038-7046).

Grabtchikov et al. (“Multimode pumped continuous-wave solid-state Raman laser”, Grabtchikov et al., Optics Letters, Vol. 29, No. 21, Nov. 1, 2004, p. 2524-2526) attributes the source of the noise to the multi-frequency operation of the Raman laser.

These noise values are too high for the majority of applications, in particular in the field of biology, generally requiring an RMS noise lower than 1%, or even lower than 0.5%.

Another drawback of the devices known in the prior art is the oscillation threshold of solid-state Raman lasers in continuous emission.

Here we are more particularly interested in compact Raman lasers using pumps of average or low power, typically of 1 W to 10 W.

For these Raman lasers, the efficiency will only be high if the Raman oscillation threshold is low (pump threshold power preferably less than 2 W and ideally less than 1 W).

An purpose of the present invention is to propose a solid-state Raman laser device, of the solid-state laser type, making it possible to obtain a continuous Raman emission with low noise.

An additional purpose of the present invention is to propose a Raman laser device, of the solid-state laser type, having a reduced pump power threshold, preferably lower than 2 W and ideally lower than 1 W.

Another purpose of the present invention is to propose a Raman laser system comprising this Raman laser device, as well as a method associated with this Raman laser device.

### DESCRIPTION OF THE INVENTION

This objective is achieved with a Raman laser device comprising the following elements:
an amplifying medium absorbent at a pump wavelength λ_{P} and emitting at an excitation wavelength λ_{S},
a Raman medium exhibiting at least one Stokes shift Δυ_{R}, such as to convert the emission at the excitation wavelength λ_{S} into a continuous emission at a Raman wavelength λ_{R},
   wherein the amplifying medium and the Raman medium belong to a Raman cavity resonant at the excitation wavelength λ_{S} and at the Raman wavelength λ_{R}.

The term “Raman pump wavelength” is also used for the excitation wavelength λ_{S}.

The term “external pump wavelength” is also used for the pump wavelength λ_{P}.

The length of the Raman medium is less than 9 mm and the sum of the gaps between each of the elements of the Raman laser device is less than 2 mm.

The length of the Raman medium can be less than 8 mm.

The length of the Raman medium can be less than 6 mm.

The length of the Raman medium can be less than 5 mm.

The length of the Raman medium can be less than 4 mm.

The length of the Raman medium can be less than 3 mm.

The sum of the gaps between each of the elements of the Raman laser device can be less than 1 mm.

In order to minimise the Raman oscillation threshold, those skilled in the art are tempted to increase the length l_{R} of the Raman medium and to reduce the size w of the pump beam. (The length l_{R} of the Raman medium was also noted l in introduction.) If the length l_{R} of the Raman medium is large, then the length l_{c} of the Raman cavity is large.

The proposed approach is new and different. It consists of reducing the length l_{c} of the Raman cavity, which is achieved by reducing the length l_{R} of the Raman medium and by reducing the gaps between the elements of the Raman laser device.

Preferably, the Raman cavity is as short as possible.

The length of the Raman cavity can be less than 10 mm, particularly if it comprises only a Raman medium and an amplifying medium.

The length of the Raman cavity can be less than 9 mm, or even less than 8 mm.

The reduced length of the cavity minimises the number of longitudinal modes likely to oscillate at the signal wavelength and the Raman wavelength. The modal stability zones are therefore wider. We have verified experimentally that it is the longitudinal mode hops which introduce most of the noise in Raman lasers.

A short cavity makes it possible to obtain a continuous emission with little noise at a Raman wavelength λ_{R} (noise less than 1% RMS, and if anything less than 0.5% RMS).

This low-noise emission is obtained without single-frequency operation being necessary, i.e. with a particularly simple device.

The Raman oscillation threshold is reduced. For example, a pump threshold power of less than 2 W is obtained at the pump wavelength λ_{P}, and even of less than 1 W at the pump wavelength λ_{P}.

These effects are unexpected, those skilled in the art being rather encouraged to prefer long Raman media in order to increase the Raman gain of said medium.

The manufacturing costs of the Raman laser device can be reduced because the Raman medium is short.

The amplifying medium at the source of the oscillation of the signal can be Nd:YAG (neodymium-doped yttrium aluminum garnet), Nd:YVO₄ (neodymium-doped yttrium orthovanadate), any crystal or glass doped with the Nd (neodymium) ion, the Yb (ytterbium) ion, or any other rare earth or transition material such as Cr (chromium) or, finally, any other amplifying medium known to a person skilled in the art. The amplifying medium can be a crystal or a glass.

The Raman wavelength λ_{R} is that which corresponds to the Stokes shift Δυ_{R} used.

The Raman cavity can comprise an input mirror and an output mirror.

Preferably, the input mirror transmits a light beam having the pump wavelength λ_{P} towards the inside of the Raman cavity. The transmission coefficient at the pump wavelength λ_{P} is for example T=99%. The input mirror is advantageously highly reflective at the excitation wavelength λ_{S}, on the internal side of the Raman cavity, with a reflection coefficient of, for example, R_{1S}=99.95%. Preferably, R_{1S} is between 99.90% and 99.99%. The input mirror is advantageously also highly reflective at the Raman wavelength λ_{R}, on the internal side of the Raman cavity, with a reflection coefficient of, for example, R_{1R}=99.95%. Preferably, R_{1R} is between 99.90% and 99.99%.

Preferably the output mirror is highly reflective at the excitation wavelength λ_{S}, on the internal side of the Raman cavity. The reflection coefficient at the excitation wavelength λ_{S} on the internal side of the Raman cavity is, for example, R_{2S}=99.95%. Preferably, R_{2S} is between 99.90% and 99.99%. The output mirror transmits at an output wavelength. The conversion used in the context of the Raman effect is more efficient in the presence of the beam at the Raman wavelength, hence the necessity of allowing only a small portion of the beam at the Raman wavelength to leave the Raman cavity. The output wavelength can be the Raman wavelength λ_{R} and the transmission coefficient T_{2R} of the output mirror at the output wavelength can be between 0.15% and 0.25%, for example T_{2R}=0.2%.

The Raman cavity can be formed linearly.

It is possible moreover to provide filtering means in the Raman cavity, to prevent stray emissions from oscillating. For example, the input and output mirrors can have transmissions lower than 99% at the stray Raman wavelengths.

The Raman laser device, can comprise moreover a non-linear frequency doubling medium situated inside Raman cavity, for doubling the frequency of the continuous emission at a Raman wavelength λ_{R}.

The output wavelength can be the wavelength after frequency doubling.

The output wavelength can be the wavelength after frequency doubling and the transmission coefficient T_{2NL} of the output mirror at the output wavelength can be between 90% and 100%, for example T_{2NL}=95%.

The Raman laser device can comprise moreover a non-linear frequency summing medium situated inside the Raman cavity.

The length of the Raman cavity can be less than 20 mm, in particular less than 15 mm, if it comprises a Raman medium, an amplifying medium, and a non-linear frequency doubling or frequency summing medium.

The excitation beam and the Raman beam can be frequency summed.

A Raman beam corresponding to a first Stockes shift and a Raman beam corresponding to a second Stockes shift can be frequency summed.

The output wavelength can be the wavelength corresponding to the sum-frequency and the transmission coefficient T_{2NL} of the output mirror at the output wavelength can be between 90% and 100%, for example T_{2NL}=95%.

According to these two latter embodiments, the output mirror is advantageously highly reflective, at at least a Raman wavelength λ_{R} that is frequency-converted with the non-linear medium (R_{2R} can be between 99.90% and 99.99%, for example 99.95%).

The non-linear medium is preferably a non-linear crystal exhibiting second order optical non-linearity properties, and comprising for example lithium triborate (LBO), Beta Barium Borate (BBO), Lithium Niobate (LiNbO₃), Bismuth Borate (BiBO), Yttrium Aluminum Borate (YAB), etc.

Preferentially, the non-linear medium is a non-linear medium exhibiting type I phase matching. The type I section is natural because the signals all have the same polarisation in Raman lasers.

A non-linear medium exhibiting Type II phase matching is also possible however. The axes of the non-linear medium can then be oriented at 45° from those of the Raman medium. A waveplate can be inserted between the non-linear medium and the Raman medium. A waveplate can make it possible to manage the polarisation rotation of the beam at the excitation wavelength λ_{S} differently from a beam at a Raman wavelength λ_{R}, and from a beam at a wavelength after frequency conversion (by a non-linear frequency doubling or frequency summing medium).

For example, in a Raman laser according to the invention with non-linear conversion by frequency summing or doubling, an output signal noise of less than 0.5% RMS (or even less than 0.2% RMS) is obtained.

For example, in a Raman laser according to the invention with non-linear conversion by frequency summing or doubling, a pump threshold power of less than 2 W at the pump wavelength λ_{P}, or even of less than 1 W at the pump wavelength λ_{P}, is obtained.

The Raman laser device can be monolithic. This has several advantages:
monolithic lasers are less sensitive to mechanical vibrations and are thus more resistant to noise;
the losses of monolithic lasers can be reduced and the Raman oscillation threshold can be lowered.

The amplifying medium and the Raman medium can be formed by a single crystal.

This single crystal can be a crystal of Nd:KGW, Nd:PbMO₄, Nd:GdVO₄, Nd:YVO₄ or the same crystals doped with Yb for example.

The total length of the Raman cavity is thus again reduced.

In order to ensure long-term, low-noise operation, it is useful to measure the noise or any parameter giving information on the noise and to adjust the optical length of the Raman laser device as soon as the noise starts to increase.

The Raman laser device can comprise means of varying its optical length and means of measuring the noise of a signal at the output of the Raman laser device.

The means of measuring noise can consist of a photodiode and an electronic measuring circuit.

The output signal can be a light beam with a Raman wavelength λ_{R}, in particular in the case where the Raman cavity does not comprise a non-linear medium.

The output signal can be a beam after frequency-conversion (by a non-linear frequency doubling or frequency summing medium), in the case where the Raman cavity comprises a non-linear medium.

Because of the means of varying the optical length of the Raman laser device, it is possible to carry out an optical length scan of this device.

The association with the means of measuring noise can make it possible to identify particularly low-noise operating zones.

Low-noise operation can correspond to an output signal noise of less than 0.5% RMS, and even of less than 0.2% RMS. It is even possible to achieve less than 0.1% RMS of noise.

As a reminder, the optical length of a medium is equal to its length multiplied by the optical index of that medium.

The means of varying the optical length of the Raman laser device can comprise an element from among the following:
a piezoelectric actuator for moving an element of the Raman laser device,
means of varying the overall temperature of the Raman laser device,
means of varying the temperature of a component of the Raman laser device,
means of varying the index of one of the media (for example crystal or glass) of the cavity by means of an electro-optic effect.

The Raman laser device can comprise feedback means acting on the optical length of the Raman laser device in response to the noise in an output signal of the Raman laser device.

A feedback algorithm can be set up to modify the optical length of the Raman laser device as a function of a noise measurement.

It is possible to bring and/or to keep the Raman laser device in a low noise operating zone, without any particular adjustment effort by a user.

A monolithic Raman laser device can make it possible to dispense with feedback means.

At least one of the components from among an input mirror and an output mirror together forming the Raman cavity can be a plane mirror.

The Raman medium can be a KTP crystal, which exhibits a very good Raman gain efficiency.

The invention also relates to a Raman laser system comprising a Raman laser device according to the invention, and a pump diode producing a continuous emission at the pump wavelength λ_{P}.

The Raman laser system can moreover comprise:
means of detecting the power of an output signal of the Raman laser device, acting on
feedback means on a supply current of the pump diode.

It is thus possible to servo-control the power of the system by acting on the supply current of the pump diode in such a way as to obtain an output beam of predetermined power from the system.

Finally, the invention relates to a method of adjusting a Raman laser device according to the invention, comprising a stage of scanning the optical length of the Raman laser device and of measuring the noise in an output signal of the Raman laser device in order to determine at least one low-noise operating zone.

The scanning can be implemented during a preliminary stage of adjustment and/or implemented during the operation of Raman laser device. The noise is preferably measured outside of the Raman cavity, on the output beam.

### DESCRIPTION OF THE FIGURES AND EMBODIMENTS

Other advantages and features of the invention will become apparent on reading the detailed description of implementations and embodiments that are in no way limitative, and from the following attached drawings:

FIG. 1 illustrates a first embodiment of a device according to the invention;

FIG. 2 illustrates a second embodiment of a device according to the invention;

FIG. 3 illustrates a third embodiment of a device according to the invention; and

FIG. 4 illustrates a first embodiment of a system according to the invention.

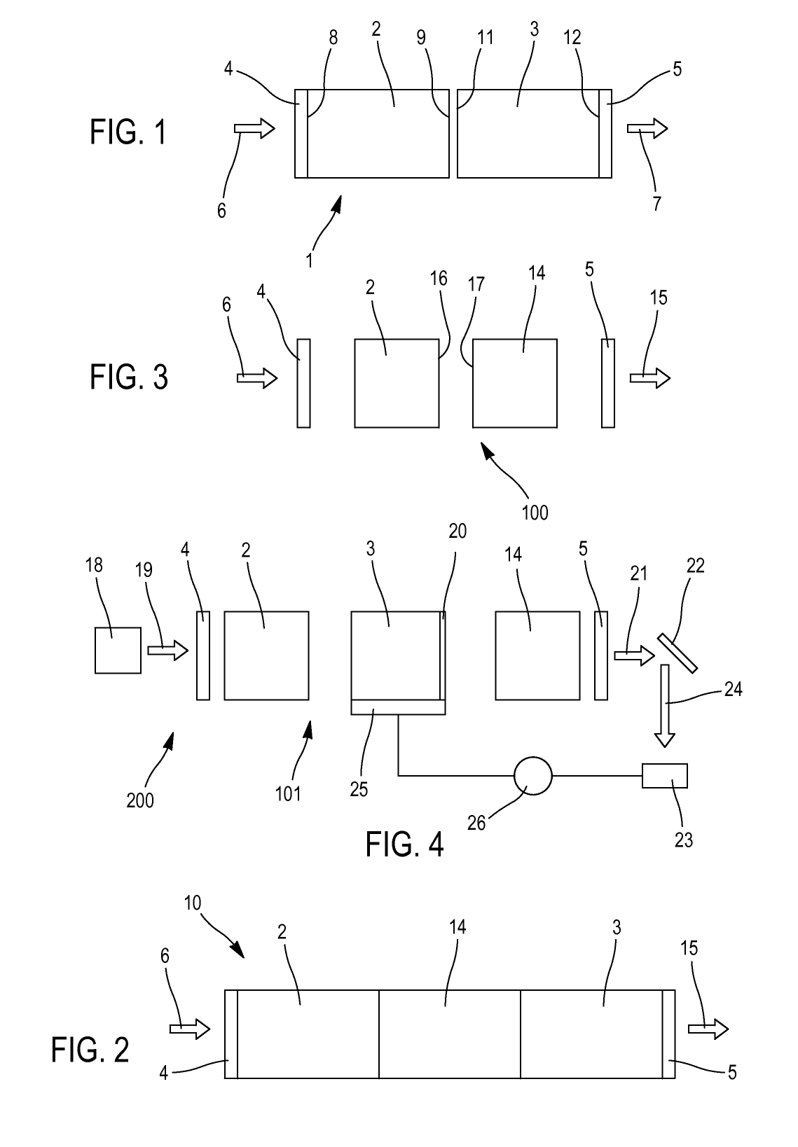

Firstly, a first embodiment of the invention as shown in FIG. 1, will be described in which a Raman laser device 1 according to the invention comprises an amplifying medium 2 and a Raman crystal 3.

The amplifying medium 2 is an Nd:YVO₄ crystal of length 1.6 mm.

The Raman crystal 3 is a YVO₄ (yttrium orthovanadate) crystal of length 1.6 mm.

The two crystals are separated by a few hundred μm.

An input mirror 4 and an output mirror 5 form a Raman cavity.

The input 4 and output 5 mirrors are plane mirrors.

The mirrors 4 and 5 can be reflective treatments deposited on a face of the amplifying medium 2 and of the Raman crystal 3 respectively.

The input mirror 4 is highly reflective (R>99.95%) at the excitation wavelength λ_{S}=1064 nm, and at the Raman wavelength λ_{R}=1176 nm.

The output mirror 5 is highly reflective (R>99.95%) at the excitation wavelength λ_{S}=1064 nm, and weakly transmitting (T=0.3%) at the Raman wavelength λ_{R}=1176 nm.

The length of the Raman cavity is less than 4 mm. This is the shortest intra-cavity Raman cavity known by the authors.

A pump diode (laser diode with an emitter of width 100 μm, not shown) emits at a wavelength λ_{P}=808 nm (see arrow 6) and provides energy to the Raman laser device 1.

The amplifying medium 2 absorbs at the pump wavelength λ_{P} and emits at an excitation wavelength λ_{S}=1064 nm. The laser oscillation threshold at 1064 nm is less than 500 mW of pump power. 30 W to 200 W of power is obtained at the excitation wavelength λ_{S}=1064 nm, inside the Raman cavity.

The Raman shift is 890 cm⁻¹ in the YVO₄ Raman crystal 3 and corresponds to a Raman emission close to 1176 nm for an excitation wavelength of between 1064 nm and 1065 nm.

The beam at the excitation wavelength λ_{S} is partially converted by the Raman crystal 3 into beam with a Raman wavelength λ_{R}. The threshold of the Raman oscillation is 1.2 W of pump power. The output signal of the Raman laser device 1 is represented by the arrow 7 and corresponds to an emission at the Raman wavelength λ_{R}. The Raman power at 1176 nm reaches 300 mW with 2.7 W of pump power at 808 nm.

We have simultaneously measured the noise and the spectrum of the Raman laser device 1 for different temperatures of the Nd:YVO₄ amplifying medium 2. Stable and low noise (<0.1% RMS) operations are observed when the Raman spectrum is stable (it is in general constituted by two longitudinal modes). For certain temperatures, the spectrum is no longer stable (it hops longitudinal modes constantly), and the noise becomes high (>1% RMS).

With lengths of Raman medium 3 varying from 1.5 mm to 6 mm, the pump power threshold can even be lower than 1 W at the wavelength λ_{P}. For example, a pump power threshold of 0.6 W is measured with a Raman medium of 3.2 mm.

The ideal is to work only with crystals having parallel faces. A parallelism better than the standard commercial value (<20″ i.e. <20 seconds of arc) is recommended. The losses are generally increased when the gap between the elements of the Raman laser device is large. It is therefore necessary to reduce this gap, or even to eliminate it by making the elements come into contact.

According to a variant which is not shown, the amplifying medium 2 is an Nd:YAG crystal emitting at an excitation wavelength equal to 1123 nm, and the Raman crystal 3 is a KTP crystal.

The Raman crystal 3 measures 5 mm×5 mm×4 mm, that is to say a length of 4 mm.

The total length of the Raman cavity is 9 mm, with a length of 5 mm for the amplifying medium 2.

The Raman laser device 1 is therefore monolithic: the total sum of the gaps between each of the elements of the Raman laser device 1 is equal to 0 mm (gap between the face inside the cavity of the input mirror 4 and the input face 8 of the amplifying medium 2, plus the gap between the output face 9 of the amplifying medium 2 and the input face 11 of the Raman crystal 3, plus the gap between the output face 12 of the Raman crystal 3 and the internal face of the cavity of the output mirror 5). The losses at the interfaces of the components are reduced in this way.

The advantage of the monolithic structure is that when the temperature of the cavity is set in the centre of a powerful and low-noise operating range, the powerful and low-noise operation is maintained over long periods (several days). A powerful and low-noise operating range corresponds to a modal stability zone as mentioned above.

According to another embodiment shown in FIG. 2, the Raman laser device 10 according to the invention comprises:
amplifying medium 2 constituted by an Nd:YVO₄ crystal of length 1.6 mm,
a non-linear medium 14 constituted by a BiBO crystal of length 4 mm,
a Raman medium 3 constituted by a YVO₄ crystal of length 1.6 mm.

The mirrors 4, 5 are deposited on the amplifying medium 2 and on the Raman medium 3. The two mirrors 4, 5 are highly reflective (R>99.9%) at the excitation wavelength (λ_{S}=1064 nm) and at the Raman wavelength (λ_{R}=1176 nm).

The output mirror 5 transmits (T=99%) at an output wavelength (see below). At least one other interface in the Raman laser device is highly reflective at the output wavelength, such that the whole of the beam at the output wavelength emerges from the same side of the Raman laser device 10.

The internal facets of the Raman laser device 10 are very poorly reflective at 1064 nm and at 1176 nm, which limits the losses.

The three crystals are in contact by molecular adhesion (without adhesive) such that the cavity is monolithic and of length 7.2 mm.

By changing the non-linear medium 14 phase matching, it is possible to favour frequency summing rather than frequency doubling:
in one configuration the BiBO crystal 14 is cut for phase matching the second harmonic generation of the Raman emission at 1176 nm. A yellow-orange emission (see arrow 15) at an output wavelength equal to 588 nm is then observed;
in another configuration the BiBO crystal is cut for phase matching the frequency sum between the signal and the Raman emission. A green-yellow emission at an output wavelength equal to 559 nm is observed.

In both cases, the Raman oscillation threshold is reached for a pump power of less than 1 W at 808 nm. By adjusting the temperature of the cavity, it was possible to exceed 100 mW of visible emission (at 588 nm and at 559 nm) with 2 W of pump power and with low-noise (<0.1% RMS) operation. This operation was maintained over a range typically of width 0.5° C.

Simply by modifying the mirrors 4, 5 of the preceding configurations, another Raman emission can be favoured: if the transmission of the mirrors 4, 5 at 1176 nm is greater than a few % and if the reflection at 1109 nm is high (greater than 99.9%), it is the line at 1109 nm corresponding to the Raman shift of 380 cm⁻¹ which oscillates. It is possible to double the frequency of this line and obtain an emission at 554.5 nm or to sum it with a beam at the excitation wavelength of 1064 nm in order to obtain an emission at 543 nm.

It is also possible to use KTP as Raman medium and obtain a Raman emission at 1148 nm (Raman shift of the order of 690 cm⁻¹).

Very similar results could be obtained by changing the YVO₄ crystal for KGW or KYW crystals or other crystals known for their Raman efficiency. It is also possible to use other emission bands of the Nd ion (for example around 0.9 μm or 1.3 μm) or other amplifying ions such as the Yb ion. Amplifying media such as Nd:KYW, Nd:YAG or crystals doped with Ytterbium associated with a Raman medium and optionally a non-linear crystal can be used in order to attain a very large number of wavelengths. In the same way, it is possible to use other non-linear crystals such as for example LBO or LiNbO₃.

In particular it is possible to attain the region of the spectrum from 561 nm to 659 nm, which cannot be obtained by frequency doubling or summing, from an infrared emission of a rare earth pumped by infrared diode.

According to a variant which is not shown, the Raman laser device 10 according to the invention comprises:
an Nd:YVO₄ crystal of length 3.2 mm, serving both as an amplifying medium 2 and as a Raman medium 3, and
a non-linear medium 14 constituted by a BiBO crystal of length 4 mm.

Another advantageous configuration of the invention, such as shown in FIG. 3, takes advantage of the fact that the xTy (x=K or R and y=P or A) crystals are both good non-linear crystals for frequency summing or doubling and good Raman media. For example KTP has two effective Raman shifts, at 270 cm⁻¹ and at 700 cm⁻¹. With a signal of about 1064 nm, it is then possible to obtain Raman emissions at 1096 nm and 1150 nm.

FIG. 3 shows a Raman laser device 100 according to the invention comprising:
amplifying medium 2 constituted by an Nd:YVO₄ crystal of length 1.6 mm, and
a non-linear medium and Raman medium 14 constituted by a KTP crystal of length 5 mm.

A KTP crystal has the advantage of being more easily optically contactable with other crystals. It is easier to deposit a reflective treatment on it because of its lower coefficient of thermal expansion.

The Raman cavity is closed by two mirrors 4 and 5.

The Raman laser device 100 emits at 548 nm.

The non-linear medium 14 is cut for phase matching for doubling the frequency of the emission at 1096 nm and its polarisation axes are oriented at 45° from those of the Nd:YVO₄ crystal.

It is desirable to insert a waveplate between the two crystals in order to obtain linearly polarized emissions at 1096 nm and at 548 nm. Such a waveplate can for example manage differently the polarisation rotation of the wave emitted by the amplifying medium, of a wave at a Raman wavelength and of the wave obtained after frequency conversion by the non-linear medium. For example, a quartz plate is used for rotating the polarisation of the Raman wave differentially with respect to the wave at 1096 nm and to the wave at 548 nm.

The non-linear medium and Raman medium 14 can also be constituted by an LBO or LiBO crystal.

FIG. 4 shows a system 200 with a Raman laser device 101 according to the invention. The Raman laser device 101 comprises a input mirror 4, an amplifying medium 2, a Raman crystal 3, a non-linear crystal 14 and an output mirror 5.

The amplifying medium 2 and the Raman crystal 3 can be formed by a single Nd:YVO4 crystal of total length 5 mm.

The non-linear crystal 14 is an LBO crystal implementing frequency doubling and having a length of 10 mm.

The total length of the Raman cavity is 16 mm (approximately 1 mm of air gaps in the Raman laser device 100).

A pump diode 18 emits a continuous pump beam represented by the arrow 19, which passes through the input mirror 4 to then be absorbed by the amplifying medium 2.

The amplifying medium 2 then emits a beam at an excitation wavelength reflected inside the Raman laser device by the input 4 and output 5 mirrors.

The Raman cavity is resonant at this excitation wavelength.

This beam having an excitation wavelength is converted by the Raman crystal 3 into a beam having a Raman wavelength, which is then frequency doubled by the non-linear crystal 14.

A mirror 20 is formed on the output face of the Raman crystal 3 for reflecting at the wavelength obtained after frequency doubling.

The different characteristics of the amplifying medium 2, the Raman crystal 3, the non-linear crystal 14, the input mirror 4 and the output mirror 5 are those described with reference to FIG. 2.

At the output of the Raman cavity, an output beam is represented by the arrow 21. The output beam is at the wavelength obtained after frequency conversion (by the non-linear medium 14).

The system 200 according to FIG. 4 comprises moreover means (not shown) of detecting the power of the output beam. Said means act over feedback means on a supply current of the pump diode 18. It is thus possible to maintain the power of the output beam substantially constant.

A sampling plate 22 makes it possible to deflect a portion 24 of the output beam to noise measuring means 23.

These noise measuring means 23 can consist of a photodiode at the input of which there is a filter which chops the continuous signal, or a photodiode at the output of which there is a high-pass filter.

The system 200 comprises moreover means 25 for varying the optical length of the Raman laser device 101.

These means 25 for varying the optical length of the Raman laser device 101 consist of a Peltier effect module which makes it possible to control the temperature of the Raman crystal 3 against which it is placed.

By finely varying the temperature of at least one element of the Raman laser device 101 (in this case the Raman crystal 3), the noisy operating ranges and the very low noise-level operating ranges are observed.

In noisy operation, the amplitude of the noise can exceed 50% of the maximum amplitude of the signal. Frequency analysis of the noise shows that it extends from low frequencies (a few Hz) up to 300 to 500 kHz.

The high amplitude of the noise and the high frequencies (>100 kHz) make the servo-control of the laser by a feedback on the pump current impossible.

Now a simple variation of 0.1° C. in the temperature of the Raman laser device 100 (in this case the temperature of the Raman crystal 3) suffices to obtain a very low-noise operation. For example, peak-to-peak noise amplitudes of less than 0.25% (that is to say noise lower than 0.1% RMS) are obtained.

The laser can thus be servo-controlled in a stable manner if the temperature is controlled very accurately (to better than 0.1° C.). The measured noise is then less than 0.2% RMS.

This servo-control is implemented by feedback means 26 receiving as input the noise measured on the output beam by the noise measuring means 23, and consequently acting on the means 25 for varying the optical length of the Raman laser device, in order to bring and then keep the Raman laser device 101 in a noiseless operating range.

The feedback loop makes it possible to ensure stable operation over several months or years.

By constructing “monolithic” Raman laser devices according to the invention (formed of crystals or glasses in optical contact with each other), it is then possible to observe low-noise (<0.5% RMS) operations maintained over several hours of operation.

With Raman monolithic and temperature controlled laser systems according to the invention, low-noise operation can be maintained over thousands of hours of operation.

Observations that are the basis of the invention can be explained as follows:

The only approach known up to the present day for minimising the Raman oscillation threshold consisted of increasing the length l_{R} of the Raman medium and reducing the size of the beam w. If l_{R} is large, then the length l_{c} of the Raman cavity is large.

The only way of reducing w is to work with a short focal length f (and therefore adding a focusing element in the Raman cavity), hardly greater than l_{c}. (0<f−l_{c}<<l_{c}).

Contrary to the prejudices of a person skilled in the art, the invention here proposes dispensing with a focusing element in the cavity, considering that the addition of a focusing element in the cavity is responsible for additional losses.

With the equipment available at the time of the invention, we work therefore with a long focal length compared with the Raman cavity length: f>2l_{c}. Thus, the Rayleigh distance Z_{R}>l_{c} and therefore the beam is collimated in the Raman cavity.

The losses induced by stray reflections are low.

It is no longer necessary to add a focusing element.

The low value of l_{c} nevertheless guarantees a small beam size.

The reduction in the length of the Raman medium is therefore counterbalanced by the small size w of the laser beam and by the low losses of the Raman cavity.

Moreover, it is considered that the zone 0<f−l_{c}<l_{c} is unfavourable for two raisons.

The first reason is the high sensitivity of w to any variation of thermal lens or of cavity length. This can be an additional source of noise.

This signifies moreover that Z_{R}<l_{c} and therefore that the beam is not collimated in the Raman cavity. It is known that any reflection outside of the collimation zone is a source of loss.

It can therefore be explained that the Raman oscillation threshold is lower for a reduced Raman cavity length, this reduced cavity length being obtained according to the invention due to a length of Raman medium of less than 9 mm and a sum of the gaps between the elements of the Raman cavity of less than 2 mm.

Moreover, the noise and the spectrum of the output signal in different Raman laser devices have been analyzed.

Contrary to the “green noise” dynamics in intra-cavity frequency doubled lasers, these analyses have unexpectedly shown that the noise in Raman laser devices is not related to the multi-frequency structure but to spectral instabilities, i.e. to longitudinal mode transitions.

It has been possible to observe noiseless, multi-frequency operation for the first time.

The experiments carried out have shown that said spectral instabilities are related to variations in the optical length of the Raman laser device (product of the lengths and the refractive indices) and in particular related to mechanical vibrations and to thermal variations.

If the temperature is servo-controlled with a setting close to the modal transition, the Raman laser device becomes noisy because very slight mechanical or thermal variations induce a change of longitudinal mode.

It proves to be that the shorter the Raman cavity is, the more separated in temperature are the spectral transition zones. Conversely, in long Raman cavities, the spectral transition zones are so close together that it is almost impossible to avoid noise due to a spectral transition.

It is therefore seen that it is advantageous to work with Raman cavities that are as short as possible because the modal stability zones are that much wider.

Work is being carried out with elements, such as the Raman crystal, the amplifying medium, and if necessary a non-linear birefringent medium, that are as short as possible.

This makes the Raman laser more resistant to thermal effects and this makes it possible to produce noiseless Raman lasers more easily.

The total length of the monolithic Raman laser device can be less than 20 mm. Advantageously, it is less than 12 mm.

Raman laser devices according to the invention composed of several separated elements can be more sensitive to vibrations and must therefore be shorter. The total length of these Raman lasers is preferably less than 15 mm. Advantageously, it is less than 10 mm.

Of course, the invention is not limited to the examples which have just been described and numerous adjustments can be made to these examples without exceeding the scope of the invention. It is for example possible to dispense with the amplifying medium. Other amplifying media and other Raman media can be used and other Raman rays of a Raman crystal can be used.

1. Raman laser device (1; 10; 100; 101) comprising the following elements:
an amplifying medium (2) absorbent at a pump wavelength λ_{P} and emitting at an excitation wavelength λ_{S},
a Raman medium (3; 14) exhibiting at least one Stokes shift Δυ_{R}, such as to convert the emission at the excitation wavelength λ_{S} into a continuous emission at a Raman wavelength λ_{R},
wherein the amplifying medium (2) and the Raman medium (3; 14) belong to a Raman cavity (4, 5) resonant at the excitation wavelength λ_{S} and at the Raman wavelength λ_{R}, characterized in that the length of the Raman medium (3; 14) is less than 9 mm and in that the sum of the gaps between each of the elements of the Raman laser device (1; 10; 100; 101) is less than 2 mm.

2. Raman laser device (10; 100; 101) according to claim 1, characterized in that it comprises moreover a non-linear frequency doubling medium (14) situated inside the Raman cavity (4, 5).

3. Raman laser device (10; 100; 101) according to claim 1, characterized in that it comprises moreover a non-linear frequency summing medium (14) situated inside the Raman cavity (4, 5).

4. Raman laser device (1; 10; 100; 101) according to claim 1, characterized in that it is monolithic.

5. Raman laser device (1; 10; 100; 101) according to claim 1, characterized in that the amplifying medium (2) and the Raman medium (3) are formed by a single crystal.

6. Raman laser device (1; 10; 100; 101) according to claim 1, characterized in that it comprises means (25) of varying its optical length and means (23) of measuring the noise of a signal at the output of the Raman laser device (1; 10; 100; 101).

7. Raman laser device (1; 10; 100; 101) according to claim 6, characterized in that the means (25) of varying the optical length of the Raman laser device comprise an element from among the following:
a piezoelectric actuator for moving an element of the Raman laser device (100),
means of varying the overall temperature of the Raman laser device (100),
means (25) of varying the temperature of a component of the Raman laser device (100),
means of varying the index of one of the media of the cavity by means of an electro-optic effect.

8. Raman laser device (1; 10; 100; 101) according to claim 6, characterized by feedback means (26) acting on the optical length of the Raman laser device (1; 10; 100; 101) in response to the noise in an output signal of the Raman laser device (1; 10; 100; 101).

9. Raman laser device (1; 10; 100; 101) according to claim 1, characterized in that at least one of the components from among an input mirror (4) and an output mirror (5) together forming the Raman cavity is a plane mirror.

10. Raman laser device (1; 10; 100; 101) according to claim 1, characterized in that the Raman medium (3; 14) is a KTP crystal.

11. Raman laser system (200), characterized in that it comprises a Raman laser device (1; 10; 100; 101) according to claim 1, and a pump diode (18) producing a continuous emission at the pump wavelength λ_{P}.

12. Raman laser system (200) according to claim 11, characterized in that it comprises moreover:
means of detecting the power of an output signal of the Raman laser device (1; 10; 100; 101), acting on
means of feedback on a supply current of the pump diode (18).

13. Method of adjusting a Raman laser device (1; 10; 100; 101) according to claim 1, characterized by a stage of scanning the optical length of the Raman laser device (1; 10; 100; 101) and of measuring the noise in an output signal of the Raman laser device (1; 10; 100; 101) in order to determine at least one low-noise operating zone.

14. Raman laser device (1; 10; 100; 101) according to claim 7, characterized by feedback means (26) acting on the optical length of the Raman laser device (1; 10; 100; 101) in response to the noise in an output signal of the Raman laser device (1; 10; 100; 101).
